(19) United States
(12) Patent Application Publication
(10) Pub. No.: US 2008/0138637 A1
(43) Pub. Date: Jun. 12, 2008

(54) Polyimide Multilayer Adhesive Film And Method For Producing The Same

(76) Inventors: Masami Yanagida, Shiga (JP); Kenji Ueshima, Hyogo (JP); Toshiyuki Komatsu, Kanagawa (JP)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/792,937

(22) PCT Filed: Dec. 7, 2005
(86) PCT No.: PCT/JP05/22467

§ 371 Date: Jun. 12, 2007

(30) Foreign Application Priority Data
Dec. 17, 2004 (JP) 2004-366535
Dec. 17, 2004 (JP) 2004-366546

(51) Int. Cl. B32B 27/16; B32B 27/06; B01J 19/08

(52) U.S. Cl. 428/473.5; 427/457

(57) ABSTRACT

An object of the present invention is to provide a polyimide multilayer adhesive film in which the thicknesses of the respective layers can be precisely measured by an infrared absorption method and a method for producing the same. In an adhesive film including a highly heat-resistant polyimide layer and an adhesive layer that contains a thermoplastic polyimide and that is disposed on at least one surface of the highly heat-resistant polyimide layer, the adhesive film is produced by a coextrusion-flow casting method and either of the highly heat-resistant polyimide layer or the adhesive layer contains, as a principal component, a polyimide resin having a functional group showing a characteristic infrared absorption wavelength. In the subsequent step of measuring the film thickness, the thickness dimensions of the respective layers are measured with an infrared absorption type thickness gauge, and the thicknesses of the respective layers during the film formation are controlled and adjusted on the basis of the data of the thickness dimensions to produce the adhesive film. Thereby, the polyimide multilayer adhesive film of the present invention can be provided.

### TECHNICAL FIELD

The present invention relates to a multilayer adhesive film including a highly heat-resistant polyimide layer and an adhesive layer that contains a thermoplastic polyimide and that is provided on at least one surface of the polyimide layer, in which the thicknesses of respective layers are controlled, and a technique for producing the film in which the thicknesses of respective layers are controlled.

### BACKGROUND ART

In recent years, demands for various printed circuit boards have been increasing with reduction in weight, reduction in size, and increase in density of electronic products. Among these, demands for flexible laminates (also referred to as “flexible printed circuit boards (FPC)” etc.) have been particularly increasing. A flexible laminate has a structure in which a circuit formed from a metal foil is provided on an insulating film.

The flexible laminate is generally produced by a method of laminating a metal foil by thermocompression bonding on a surface of a substrate with an adhesive material therebetween. The substrate is a flexible insulating film composed of an insulating material of various type. As the insulating film, a polyimide film or the like is preferably used. As the adhesive material, a thermosetting adhesive such as an epoxy or an acrylic adhesive is generally used (hereinafter, the FPC including such a thermosetting adhesive is also referred to as “three-layer FPC”).

The thermosetting adhesive is advantageous in that bonding at relatively low temperatures can be performed. However, as the requirements for characteristics, such as heat resistance, flexibility, and electrical reliability, become more stringent, the three-layer FPC including the thermosetting adhesive will have difficulties in satisfying such requirements. To overcome this problem, a material produced by directly laminating a metal layer on an insulating film and FPC (hereinafter also referred to as “two-layer FPC”) having an adhesive layer made of a thermoplastic polyimide compound have been proposed. The two-layer FPC has properties superior to those of the three-layer FPC, and is expected to become an industrially useful product.

Examples of the method for producing a flexible metal-clad laminate used for a two-layer FPC include a casting method in which a polyamic acid, i.e., a polyimide compound precursor, is applied by flow-casting the polyamic acid on a metal foil and imidization is then performed; a metallizing method in which a metal layer is directly formed on a polyimide film by sputtering or plating; and a laminating method in which a polyimide film and a metal foil are laminated with a thermoplastic polyimide compound therebetween. Among these, the laminating method is advantageous in that the range of the thickness of the metal foil usable in this method is wider than that in the casting method and the cost of apparatus is lower than that of the metallizing method. As the apparatus for lamination, a hot roll laminator in which lamination is continuously performed while winding off a roll of material, a double belt press, or the like is used.

A multilayer adhesive film (hereinafter referred to as “adhesive film”) containing a polyimide film having a thermoplastic polyimide compound layer on at least one surface of the polyimide film has been widely used as a substrate material for the laminating method.

Examples of a method for producing such an adhesive film containing a polyimide base film include a coating method of coating, with a solution of a thermoplastic polyimide compound or a precursor thereof, at least one surface of a highly heat-resistant polyimide base film by a roll coater or a die coater and drying the solution; a simultaneous extrusion film-forming method of extruding a solution of a highly heat-resistant polyimide compound serving as a base material and/or a solution of a precursor thereof (hereinafter referred to as “highly heat-resistant polyimide compound varnish”) and a solution of a thermoplastic polyimide compound and/or a solution of a precursor thereof (hereinafter referred to as “thermoplastic polyimide compound varnish”) with extrusion dies for each solution wherein the dies are disposed in the direction parallel to the film-forming direction to laminate the films and drying the laminated film; and an extrusion-coating method of extruding a highly heat-resistant polyimide compound varnish with an extrusion die, applying a thermoplastic polyimide compound varnish with a roll coater or a die coater, and drying the varnish. Another example of The methods is a thermal lamination method of bonding a thermoplastic polyimide film on at least one surface of a highly heat-resistant polyimide base film under heating.

In the adhesive films obtained by these methods, the adhesiveness between different types of polyimide resins must be improved. However, in general, the adhesiveness between different types of polyimide resins is not satisfactory and it is often difficult to obtain an adhesive film having a satisfactory strength. As a method for improving the adhesiveness between different types of polyimide resins, a method for producing an adhesive film in which a liquid film having a multilayer structure is formed using a solution containing different types of polyimide resins and/or a solution containing precursors thereof, the liquid film is flow-cast on a smooth substrate, and the liquid film is then dried by heating is the most effective. Examples of a known method for forming a multilayer liquid film include a coextrusion film-forming method of extruding using a multilayer die (for example, Patent Documents 1 and 2), a method using a slide die (for example, Patent Document 3), and a sequential coating method.

A problem in the above production methods is that the thickness of a continuously produced adhesive film is difficult to adjust in substantial real time. In order to adjust the thickness of a continuously produced adhesive film in substantial real time, the thicknesses of respective layers of the adhesive film must be measured with high accuracy online. However, hitherto, it is extremely difficult to measure the thicknesses of respective layers of an adhesive film with high accuracy online, and thus an adhesive film having a uniform thickness is difficult to produce.

Examples of a method for measuring the thicknesses of respective layers of a multilayer film with high accuracy include an optical interference method and an infrared absorption method. In view of a requirement for a short measurement time or the like, the infrared absorption method is preferably used as a method for measuring online. However, although the layers of the adhesive film are different in view of a highly heat-resistant polyimide and a thermoplastic polyimide, the layers are composed of polyimide resins whose molecular structures are extremely similar to each other. Therefore, in the infrared absorption method in which the difference in the infrared absorption intensities in the layers is converted to the thickness, there has been a problem of difficulty in measuring the thickness precisely.

In these multilayer films, the accuracy of the thickness dimensions in respective layers is one of the important specifications. Regarding a method for adjusting the thickness dimensions of respective layers of a multilayer film, for example, in the coating method of coating a resin solution on a base film, the thickness of the coating film is adjusted by controlling the discharge quantity of a coating die or by controlling the clearance between a roll coater and a base film. In the extrusion film-forming method using extrusion dies, the thickness dimension of the film is adjusted by controlling the resin temperature with a heater embedded in a lip part of a multilayer die or the thickness dimension of the film is adjusted by controlling the cross-sectional area of the flow path of each layer with a valve (for example, Patent Document 4).

In addition, a method in which the thickness dimensions of respective layers are measured with an infrared absorption type or an optical interference type thickness gauge that can measure the thickness dimensions of respective layers of a multilayer film, and the data of the thickness dimensions is fed back to film-thickness control means (for example, Patent Document 5) is known.

### Patent Document 1: Japanese Patent No. 2946416

### Patent Document 2: Japanese Unexamined Patent Application Publication No. 7-214637

### Patent Document 3: Japanese Unexamined Patent Application Publication No. 2003-342390

### Patent Document 4: Japanese Unexamined Patent Application Publication No. 2000-127227

### Patent Document 5: Japanese Unexamined Patent Application Publication No. 2000-71309

### DISCLOSURE OF INVENTION

### Problems to be Solved by the Invention

The present invention has been made in view of the above problems, and it is an object of the present invention to provide a polyimide multilayer adhesive film in which the variation in the thickness of the adhesive film and the variations in the thicknesses of respective layers in the film are small, and a method for producing the same, by allowing the thicknesses of respective layers to be accurately measured by an infrared absorption method.

In all the methods, i.e., the method of controlling the discharge quantity of a coating die or the clearance between a roll coater and a base film, the method of adjusting the thickness dimension of a film with a heater embedded in a lip part of a multilayer die, and the method of adjusting the thickness dimension of a film by controlling the cross-sectional area of the flow path of each layer with a valve, the thickness dimensions of the respective layers of a formed multilayer film must be measured with high accuracy, and the data of the thickness dimensions must be fed back to film-thickness control means so as to adjust and control the each thickness dimension of the film.

In other words, the problem in the above methods is that the thicknesses of respective layers of a continuously produced multilayer film are difficult to adjust substantially in real time. For example, the multilayer film may be sampled by cutting and the cross-section of the film may be observed and measured with a microscope or the like. In this method, however, the measured data cannot be fed back to the film-forming process substantially in real time. In order to adjust the thickness of a continuously produced multilayer film substantially in real time, the thickness dimensions of respective layers of the multilayer film must be measured with high accuracy online. However, hitherto, it is extremely difficult to measure the thicknesses of respective layers of a multilayer film with high accuracy online.

For example, a contact type dial gauge is used as a system in which a film thickness measuring device is set online. In such a case, although the total thickness dimension of a multilayer film can be measured, the thickness dimensions of respective layers cannot be measured in principle.

On the other hand, in the method described in Patent Document 2, the thickness dimensions of respective layers cannot be precisely measured in a multilayer film including films composed of materials having the same infrared absorption wavelength or refractive index. In particular, in multilayer films containing polyimide resins as principal materials, although the layers are different in view of a highly heat-resistant polyimide and a thermoplastic polyimide, the layers are composed of polyimide resins whose molecular structures are extremely similar to each other. Consequently, a characteristic infrared absorption wavelength is not generated in respective layers. Therefore, in the infrared absorption method in which the analysis of respective layers and the conversion of the thickness dimension are performed on the basis of the difference in the infrared absorption wavelengths and the difference in the amounts of absorption of the infrared rays, it is difficult to precisely measure the thickness dimension. Furthermore, the thickness dimension cannot be fed back substantially in real time to film-thickness control means in the film-forming process. Thus, there has been a problem that multilayer films having a stable and highly accurate thickness dimension cannot be produced.

### Means for Solving the Problems

In view of the problems described above, the present inventors have conducted intensive research and uniquely found the requirements for a multilayer film in which the thickness dimensions of respective layers can be precisely measured with an infrared absorption type thickness gauge, and a film-thickness control system including a step of forming a film having a stable thickness dimension by feeding back the data of the thickness dimension. The above problems are solved by the following novel method for producing a multilayer film, and thus the present invention has been accomplished.

The present invention relates to an adhesive film including a highly heat-resistant polyimide layer and an adhesive layer that contains a thermoplastic polyimide and that is disposed on at least one surface of the highly heat-resistant polyimide layer, wherein either the highly heat-resistant polyimide layer or the adhesive layer contains, as a principal component, a polyimide resin having a functional group showing a characteristic infrared absorption wavelength.

A preferred embodiment relates to the above adhesive film, wherein the functional group showing a characteristic infrared absorption wavelength is methyl group, sulfone group, or fluoromethyl group.

A further preferred embodiment relates to the above adhesive film produced by laminating the adhesive layer containing a thermoplastic polyimide on at least one surface of the highly heat-resistant polyimide layer by a coextrusion-flow casting method.

In more detail, 1) a method for producing a polyimide resin-containing multilayer film having at least two layers, including forming a multilayer film including at least one layer containing, as a principal component, a polyimide resin having a functional group showing a characteristic infrared absorption wavelength; irradiating the multilayer film with infrared rays in a thickness direction of the film to measure a distribution of absorption wavelengths of the infrared rays, and calculating thickness dimensions of the respective layers from the amounts of absorption of the infrared rays in the wavelength regions characteristic of the respective layers; and feeding back the calculated data of the thickness dimensions to the step of forming, and controlling the thickness dimension of each layer in the step of forming.

2) The method for producing a polyimide multilayer adhesive film according to 1) above, wherein the multilayer film includes a layer containing a highly heat-resistant polyimide resin and a layer containing a thermoplastic polyimide resin.
3) The method for producing a polyimide multilayer adhesive film according to 2) above, wherein the multilayer film has a structure in which the layers containing a thermoplastic resin polyimide resin are provided on both surfaces of the layer containing a highly heat-resistant polyimide resin.
4) The method for producing a polyimide multilayer adhesive film according to any one of 1) to 3) above, wherein the functional group showing a characteristic infrared absorption wavelength is at least one functional group selected from methyl group, sulfone group, and fluoromethyl group.
5) The method for producing a polyimide multilayer adhesive film according to any one of 1) to 4) above, wherein, in the step of forming, the adhesive film is produced by a coextrusion-flow casting method using a solution of a polyimide resin having a functional group showing a characteristic infrared absorption wavelength or the precursor thereof.
6) The method for producing a polyimide multilayer adhesive film according to any one of 1) to 5) above, wherein, in the step of forming, the film is formed by coating, with a solution containing a polyamic acid or a polyimide resin, the surface of a film having at least one layer containing a polyimide resin, and thermally drying the film.

### ADVANTAGES OF THE INVENTION

According to the present invention, an adhesive film in which the thicknesses of respective layers can be precisely measured with an infrared absorption method can be provided.

In the production of a polyimide multilayer film of the present invention, the multilayer polyimide film includes polyimide resin layers each having a characteristic infrared absorption wavelength. In the subsequent step of measuring the film thickness, the multilayer film is irradiated with infrared rays in the thickness direction, the distribution of the absorption wavelengths of the passed infrared rays is measured, the thickness dimensions of respective layers are calculated from the amounts of absorption of the infrared rays in the wavelength regions characteristic of the respective layers, and the data of the thickness dimensions is fed back to the film-forming process to control and adjust the thicknesses of respective layers. Therefore, a polyimide multilayer film that has a uniform thickness dimension of each layer and that is excellent in continuous productivity can be produced.

Embodiments of the present invention will be described below.

According to a method for producing a polyimide multilayer film used in the present invention, the method for producing a polyimide resin-containing multilayer film having at least two layers includes a step of forming a multilayer film including at least one layer containing, as a principal component, a polyimide resin having a functional group showing a characteristic infrared absorption wavelength; a step of irradiating the multilayer film with infrared rays in the thickness direction of the film to measure the distribution of the absorption wavelengths of the infrared rays, and calculating the thickness dimensions of the respective layers from the amounts of absorption of the infrared rays in the wavelength regions characteristic of the respective layers; and a step of feeding back the calculated data of the thickness dimensions to the multilayer film-forming step, and controlling the thickness dimension of each layer in the film-forming step.

Description will be made of the step of forming a multilayer film including at least one layer containing, as a principal component, a polyimide resin having a functional group showing a characteristic infrared absorption wavelength.

In the present invention, as described below, since the distribution of the absorption wavelengths of infrared rays is measured by irradiating the multilayer film with infrared rays in the thickness direction of the film and the thickness dimensions of respective layers are calculated from the amounts of absorption of the infrared rays in the wavelength regions characteristic of the respective layers, it is important that the multilayer film has such a structure that any of the layers contain a polyimide resin having a functional group showing a characteristic infrared absorption wavelength in such an amount that allows this polyimide to be the principal component of the layer(s). Depending on which one of the layers of the multilayer film to be measured in thickness, it may be decided which one of the layers is designed to contain a polyimide resin having a functional group showing a characteristic infrared absorption wavelength and which functional group showing characteristic infrared absorption wavelength is selected in combination. As a multilayer film, a structure including a highly heat-resistant polyimide layer and an adhesive layer containing a thermoplastic polyimide, the adhesive layer being provided on at least one surface of the highly heat-resistant polyimide layer, will be described together with specific examples.

### BRIEF DESCRIPTION OF THE DRAWINGS

FIG. 1 shows an embodiment of a method for producing a polyimide multilayer adhesive film of the present invention.

FIG. 2 shows another embodiment of a method for producing a polyimide multilayer adhesive film of the present invention.

FIG. 3 shows an embodiment of a polyimide multilayer extrusion die.

### REFERENCE NUMERALS

10: polyimide multilayer adhesive film
21: support
22: drying furnace
23: tenter furnace
24: take-up unit
25: feeding unit
31: infrared absorption type thickness gauge
32: control system
33: film-thickness control means
40: multilayer extrusion die
41: injection path
42: manifold
43: heater
44: flow path
45: junction part
46: circulation path for cooling medium
47: motor type lip-width-adjusting mechanism
51: coating die

### BEST MODE FOR CARRYING OUT THE INVENTION

Embodiments of the present invention will now be described. A method for producing a polyimide multilayer adhesive film used in the present invention includes a polyimide resin-containing multilayer adhesive film having at least two layers and a method for producing the same.

The multilayer adhesive film includes a highly heat-resistant polyimide layer and an adhesive layer containing a thermoplastic polyimide, the adhesive layer being provided on at least one surface of the highly heat-resistant polyimide layer. Either of the highly heat-resistant polyimide layer or the adhesive layer contains, as a principal component, a polyimide resin having a functional group showing a characteristic infrared absorption wavelength.

An infrared absorption type multilayer film thickness measuring device attains a higher S/N ratio, when either of the highly heat-resistant polyimide layer or the adhesive layer contains, as a principal component, a polyimide resin having a functional group showing a characteristic infrared absorption wavelength. The higher S/N ratio allows highly accurate measurement of the thicknesses of respective layers.

The features of the embodiments of the present invention will be further described.

According to a method for producing a polyimide multilayer adhesive film used in the present invention, the method for producing a polyimide resin-containing multilayer film having at least two layers includes a step of forming a multilayer film including at least one layer containing, as a principal component, a polyimide resin having a functional group showing a characteristic infrared absorption wavelength; a step of irradiating the multilayer film with infrared rays in the thickness direction of the film to measure the distribution of the absorption wavelengths of the infrared rays, and calculating the thickness dimensions of the respective layers from the amounts of absorption of the infrared rays in the wavelength regions characteristic of the respective layers; and a step of feeding back the calculated data of the thickness dimensions to the multilayer film-forming step, and controlling a the thickness dimension of each layer in the film-forming step.

Description will be made of the step of forming a multilayer film including at least one layer containing, as a principal component, a polyimide resin having a functional group showing a characteristic infrared absorption wavelength.

In the present invention, as described below, since the distribution of the absorption wavelengths of infrared rays is measured by irradiating the multilayer film with infrared rays in the thickness direction of the film and the thickness dimensions of respective layers are calculated from the amounts of absorption of the infrared rays in the wavelength regions characteristic of the respective layers, it is important that the multilayer film have such a structure that any of the layers contains a polyimide resin having a functional group showing a characteristic infrared absorption wavelength in such an amount that the polyimide resin becomes the principal component of the layer. Depending on which one of the layers of the multilayer film to be measured in thickness, it may be decided which one of the layers is designed to contain a polyimide resin having a functional group showing a characteristic infrared absorption wavelength is used and which functional group showing a characteristic infrared absorption wavelength is selected in combination. As a multilayer film, a structure including a highly heat-resistant polyimide layer and an adhesive layer containing a thermoplastic polyimide, the adhesive layer being provided on at least one surface of the highly heat-resistant polyimide layer, will be described together with specific examples.

### <Highly Heat-Resistant Polyimide Layer>

The molecular structure and the thickness of the highly heat-resistant polyimide layer of the present invention are not particularly limited as long as the layer contains 90 weight percent or more of a non-thermoplastic polyimide resin. The non-thermoplastic polyimide resin used for the highly heat-resistant polyimide layer is produced using a polyamic acid as a precursor. The polyamic acid may be prepared by any known method. In general, the polyamic acid is prepared by dissolving substantially equimolar amounts of an aromatic tetracarboxylic dianhydride and an aromatic diamine in an organic solvent, and stirring the resulting solution under controlled temperature conditions until the polymerization between the acid dianhydride and the diamine is completed. The resulting polyamic acid solution generally has a concentration of 5 to 35 weight percent and preferably 10 to 30 weight percent. In this range of concentration, a suitable molecular weight and solution viscosity can be obtained.

As the polymerization method, any known method or a combination of known methods may be employed. The polymerization method for producing a polyamic acid is characterized by the order of addition of monomers, and by controlling the order of addition of monomers, the physical properties of the resulting polyimide can be controlled. Accordingly, in the present invention, any method for adding monomers may be employed in the polymerization for a polyamic acid. Examples of typical polymerization methods include the followings:

1) A polymerization method in which an aromatic diamine is dissolved in a polar organic solvent, and is then allowed to react with a substantially equimolar amount of an aromatic tetracarboxylic dianhydride.
2) A polymerization method in which an aromatic tetracarboxylic dianhydride is allowed to react with fewer moles of an aromatic diamine compound in a polar organic solvent to prepare a prepolymer having an acid anhydride group at each terminal, and an aromatic diamine compound is then added in such an amount that makes up a substantially equimolar amount of the aromatic diamine compound with respect to the aromatic tetracarboxylic dianhydride in the whole process.
3) A polymerization method in which an aromatic tetracarboxylic dianhydride is allowed to react with excessive moles of an aromatic diamine compound in a polar organic solvent to prepare a prepolymer having an amino group at each terminal, an aromatic diamine compound is further added to the prepolymer, and an aromatic tetracarboxylic dianhydride is then added in such an amount that makes up a substantially equimolar amount of the aromatic tetracarboxylic dianhydride with respect to the aromatic diamine compound in the whole process.
4) A polymerization method in which an aromatic tetracarboxylic dianhydride is dissolved and/or dispersed in a polar organic solvent and substantially equimolar amount of an aromatic diamine compound is then added.
5) A polymerization method in which a mixture of substantially equimolar amounts of an aromatic tetracarboxylic dianhydride and an aromatic diamine is allowed to react in a polar organic solvent.
These methods may be employed alone or partially combined.

In the present invention, a polyamic acid prepared by any one of the above polymerization methods may be used, and the polymerization method is not particularly limited.

In the present invention, the use of a polymerization method in which a prepolymer is prepared using a diamine component having a rigid structure, which is described below, is also preferable. By employing this method, a polyimide film having a high elastic modulus and a low hygroscopic expansion coefficient tends to be easily produced. In this method, the molar ratio between a diamine having a rigid structure and an acid dianhydride used in the preparation of the prepolymer is preferably in the range of 100:70 to 100:99 or 70:100 to 99:100, and more preferably in the range of 100:75 to 100:90 or 75:100 to 90:100. If the ratio is below the above range, the effect of improving the elastic modulus and the hygroscopic expansion coefficient is not easily obtained. If the ratio exceeds the above range, problems, such as an excessively low linear expansion coefficient and a low tensile elongation, may arise.

Materials used for the polyamic acid composition according to the present invention will now be described.

Examples of the appropriate tetracarboxylic dianhydride that may be used in the present invention include pyromellitic dianhydride, 2,3,6,7-naphthalenetetracarboxylic dianhydride, 3,3′,4,4′-biphenyltetracarboxylic dianhydride, 1,2,5,6-naphthalenetetracarboxylic dianhydride, 2,2′,3,3′-biphenyltetracarboxylic dianhydride, 3,3′,4,4′-benzophenonetetracarboxylic dianhydride, 4,4′-oxyphthalic dianhydride, 2,2-bis(3,4-dicarboxyphenyl)propane dianhydride, 3,4,9,10-perylenetetracarboxylic dianhydride, bis(3,4-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)ethane dianhydride, oxydiphthalic dianhydride, bis(3,4-dicarboxyphenyl)sulfone dianhydride, p-phenylenebis(trimellitic acid monoester anhydride), ethylenebis(trimellitic acid monoester anhydride), bisphenol-A bis(trimellitic acid monoester anhydride), and analogues thereof. These may be used alone or as a mixture in any desired mixing ratio.

Among these acid dianhydrides, in particular, it is preferable to use at least one selected from the group consisting of pyromellitic dianhydride, 3,3′,4,4′-benzophenonetetracarboxylic dianhydride, 4,4′-oxyphthalic dianhydride, and 3,3′,4,4′-biphenyltetracarboxylic dianhydride.

Among these acid dianhydrides, the amount of use of at least one selected from 3,3′,4,4′-benzophenonetetracarboxylic dianhydride, 4,4′-oxyphthalic dianhydride, and 3,3′,4,4′-biphenyltetracarboxylic dianhydride is preferably 60 mole percent or less, more preferably 55 mole percent or less, and still more preferably 50 mole percent or less relative to the total acid dianhydride. In the case where at least one selected from 3,3′,4,4′-benzophenonetetracarboxylic dianhydride, 4,4′-oxyphthalic dianhydride, and 3,3′,4,4′-biphenyltetracarboxylic dianhydride is used in an amount exceeding the above range, the glass transition temperature of the resulting polyimide film may become excessively low or the storage modulus during heating may become excessively low, resulting in a difficulty in forming a film itself.

When pyromellitic dianhydride is used, the amount used is preferably 40 to 100 mole percent, more preferably 45 to 100 mole percent, and particularly preferably 50 to 100 mole percent. By using pyromellitic dianhydride in the above range, the glass transition temperature and the storage modulus during heating can be readily maintained in the suitable range for use or film formation.

Examples of the appropriate diamine that may be used for the polyamic acid composition, i.e., a precursor of the non-thermoplastic polyimide according to the present invention, include 4,4′-diaminodiphenylpropane, 4,4′-diaminodiphenylmethane, benzidine, 3,3′-dichlorobenzidine, 3,3′-dimethylbenzidine, 2,2′-dimethylbenzidine, 3,3′-dimethoxybenzidine, 2,2′-dimethoxybenzidine, 4,4′-diaminodiphenyl sulfide, 3,3′-diaminodiphenyl sulfone, 4,4′-diaminodiphenyl sulfone, 4,4′-oxydianiline, 3,3′-oxydianiline, 3,4′-oxydianiline, 1,5-diaminonaphthalene, 4,4′-diaminodiphenyldiethylsilane, 4,4′-diaminodiphenylsilane, 4,4′-diaminodiphenylethylphosphine oxide, 4,4′-diaminodiphenyl-N-methylamine, 4,4′-diaminodiphenyl-N-phenylamine, 1,4-diaminobenzene(p-phenylenediamine), 1,3-diaminobenzene, 1,2-diaminobenzene, bis{4-(4-aminophenoxy)phenyl}sulfone, bis{4-(4-aminophenoxy)phenyl}propane, bis{4-(3-aminophenoxy)phenyl}sulfone, 4,4′-bis(4-aminophenoxy)biphenyl, 4,4′-bis(3-aminophenoxy) biphenyl, 1,3-bis(3-aminophenoxy)benzene, 1,3-bis(4-aminophenoxy)benzene, 1,3-bis(4-aminophenoxy)benzene, 1,3-bis(3-aminophenoxy)benzene, 3,3′-diaminobenzophenone, 4,4′-diaminobenzophenone, and analogues thereof.

As the diamine component, a rigid structure-containing diamine and a flexible structure-containing amine may be used together. In such a case, the molar ratio of the rigid structure-containing diamine to the flexible structure-containing diamine is preferably 80/20 to 20/80, more preferably 70/30 to 30/70, and particularly preferably 60/40 to 30/70. If the ratio of the rigid structure-containing diamine exceeds the above range, the tensile elongation of the resulting film tends to be decreased. If the ratio of the rigid-structure-containing diamine is below the above range, the glass transition temperature may become excessively low or the storage modulus during heating may become excessively low, resulting in a problem of, for example, a difficulty in forming a film.

In the present invention, the rigid structure-containing diamine is a diamine represented by general formula (I):

NH₂—R₂—NH₂ General formula (I)

(wherein R₂ is a group selected from the group consisting of divalent aromatic groups represented by general formula group (1):

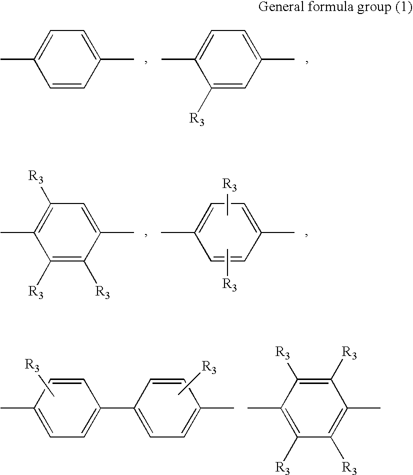

wherein R₃ is, identically or independently, a group selected from the group consisting of H—, CH₃—, —OH, —CF₃, —SO₄, —COOH, —CO—NH₂, Cl—, Br—, F—, and CH₃O—).

The flexible structure-containing diamine is a diamine having a flexible structure, such as an ether group, a sulfone group, a ketone group, or a sulfide group, and is preferably a diamine represented by general formula (II):

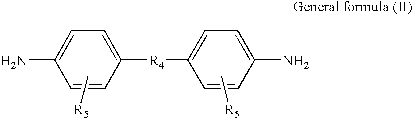

(wherein R₄ is a group selected from the group consisting of divalent organic groups represented by general formula group (2)

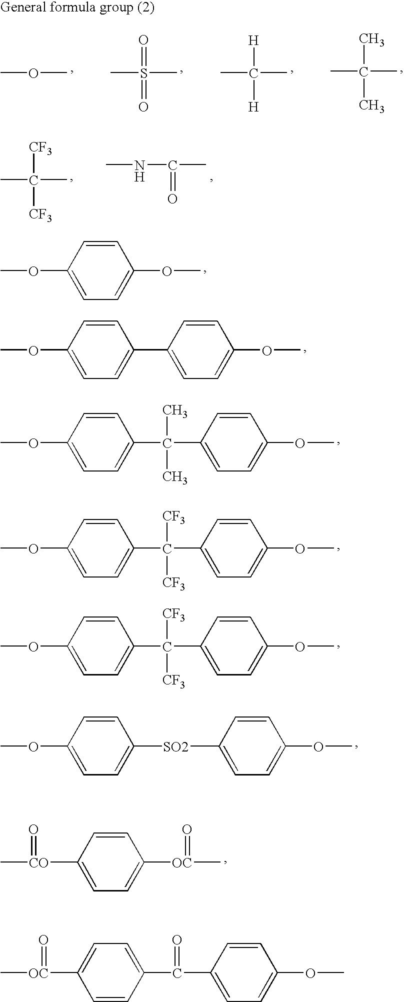

and R₅ is, identically or independently, a group selected from the group consisting of H—, CH₃—, —OH, —CF₃, —SO₄, —COOH, —CO—NH₂, Cl—, Br—, F—, and CH₃O—).

The polyimide film used in the present invention can be produced by appropriately selecting the types and the mixing ratio of the aromatic acid dianhydride and the aromatic diamine within the above range so that the resulting film has desired properties.

Any solvent that dissolves the polyamic acid may be suitably used for synthesizing the polyamic acid. Examples of the solvent include amide solvents such as N,N-dimethylformamide, N,N-dimethylacetamide, and N-methyl-2-pyrrolidone. Among these, N,N-dimethylformamide and N,N-dimethylacetamide can be particularly preferably used.

Furthermore, in order to improve various properties of the film, such as slidability, thermal conductivity, electric conductivity, corona resistance, and loop stiffness, a filler may be incorporated. Any filler may be used, but preferred examples of the filler include silica, titanium oxide, alumina, silicon nitride, boron nitride, calcium hydrogen phosphate, calcium phosphate, and mica.

The particle size of the filler depends on the film property to be modified and the type of the filler to be added, and is not particularly limited. The average particle size is generally 0.05 to 100 μm, preferably 0.1 to 75 μm, more preferably 0.1 to 50 μm, and particularly preferably 0.1 to 25 μm. If the particle size is below the above range, the modification effect may not be easily exhibited. If the particle size exceeds the above range, the surface quality may be significantly impaired or the mechanical properties may be significantly degraded. The number of parts of the filler to be used also depends on the film property to be modified, the particle size of the filler, and the like, and is not particularly limited. The amount of filler added is generally 0.01 to 100 parts by weight, preferably 0.01 to 90 parts by weight, and more preferably 0.02 to 80 parts by weight relative to 100 parts by weight of the polyimide. If the amount of filler is below the above range, the modification effect of the filler may not be easily exhibited. If the amount of filler exceeds the above range, the mechanical properties of the film may be significantly degraded. The filler may be incorporated by any one of the following methods:

1. A method in which the filler is added to a polymerization reaction solution before or during the polymerization.
2. A method in which the filler is mixed with a three-roll mill or the like after the completion of the polymerization.
3. A method in which a dispersion liquid containing the filler is prepared and mixed with an organic solvent solution of a polyamic acid.

The method in which the dispersion liquid containing the filler is mixed with the polyamic acid solution, in particular, immediately before the formation of a film, is preferred because the contamination of the production line with the filler can be minimized. When the dispersion liquid containing the filler is prepared, the same solvent as that used for polymerizing the polyamic acid is preferably used. Furthermore, in order to disperse the filler satisfactorily and to stabilize the dispersion state, a dispersant, a thickening agent, or the like may be used to such an extent that does not affect physical properties of the resulting film.

A solution containing the precursor of the non-thermoplastic polyimide resin thus obtained is also referred to as a “solution containing the precursor of the highly-heat resistant polyimide”.

### <Thermoplastic Polyimide Layer>

Regarding to the thermoplastic polyimide layer of the present invention, the content of the thermoplastic polyimide resin in the layer, the molecular structure, and the thickness of the layer are not particularly limited as long as significant adhesion can be exhibited by a laminating method. However, in order to exhibit significant adhesion, preferably, the thermoplastic polyimide layer substantially contains the thermoplastic polyimide resin in an amount of 50 weight percent or more.

Preferred examples of the thermoplastic polyimide contained in the thermoplastic polyimide layer include thermoplastic polyimides, thermoplastic polyamideimides, thermoplastic polyetherimides, and thermoplastic polyesterimides. Among these, in view of low hygroscopicity, thermoplastic polyesterimides are particularly suitably used.

The thermoplastic polyimide contained in the thermoplastic polyimide layer of the present invention can be produced by conversion reaction of a polyamic acid, which is a precursor of the polyimide. As in the case of the precursor of the polyimide of the highly heat-resistant polyimide layer, any known method can be used as a method for preparing the polyamic acid.

The thermoplastic polyimide of the present invention preferably has a glass transition temperature (Tg) in the range of 150° C. to 300° C. from the viewpoint that the lamination can be performed with an existing apparatus and the heat resistance of the resulting metal-clad laminate is not impaired. The glass transition temperature (Tg) can be determined from the inflection point of the storage modulus measured with a dynamic viscoelasticity analyzer (DMA).

The polyamic acid, which is the precursor of the thermoplastic polyimide used in the present invention, is also not particularly limited, and any known polyamic acid can be used. Regarding the production of a polyamic acid solution, the same starting materials and production conditions as those described above can be used.

The various properties of the thermoplastic polyimide can be adjusted by variously combining the starting materials used. In general, as the ratio of a rigid structure-containing diamine increases, the glass transition temperature increases and/or the storage modulus during heating increases. As a result, the adhesion and the processability are undesirably decreased. The ratio of the rigid structure-containing diamine is preferably 40 mole percent or less, more preferably 30 mole percent or less, and particularly preferably 20 mole percent or less.

A preferred specific example of the thermoplastic polyimide resin is a polyimide resin prepared by polymerizing an acid dianhydride, e.g., a biphenyltetracarboxylic dianhydride and a diamine having an aminophenoxy group.

Furthermore, in order to control the properties of the adhesive film of the present invention, an inorganic filler or organic filler and other resins may be incorporated according to need.

### <Combination of Polyimide Molecules in Respective Layers>

In the present invention, it is essential that either the highly heat-resistant polyimide layer or the adhesive layer contain, as a principal component, a polyimide resin having a functional group showing a characteristic infrared absorption wavelength. When adhesive layers are provided on both surfaces of the highly heat-resistant polyimide layer, only one of the adhesive layers, only the highly heat-resistant polyimide layer, or all the layers may contain, as a principal component, the polyimide resin having a functional group showing a characteristic infrared absorption wavelength. In the present invention, the functional group showing a characteristic infrared absorption wavelength is a functional group showing an amount of absorption that can be distinctly detected with a film thickness measuring device when irradiated with infrared rays having wave numbers of 400 cm⁻¹ to 4,000 cm⁻¹, and is not particularly limited. Considering the properties of the resulting adhesive film, methyl group, sulfone group, or fluoromethyl group is particularly preferred.

Examples of a method for introducing the functional group showing a characteristic infrared absorption wavelength to a polyimide resin include the followings:

1) A method in which a monomer containing the functional group is used as a monomer for producing the polyimide resin.
2) A method in which the functional group is grafted to the polyimide resin or a polyamic acid serving as the precursor.

In view of the production cost, method 1) is particularly preferably employed. Preferred examples of the monomers used in method 1) include acid dianhydrides, such as 2,2-bis(3,4-dicarboxyphenyl)propane dianhydride, bis(3,4-dicarboxyphenyl)sulfone dianhydride, and 5,5′-2,2,2-trifluoro-1-(trifluoromethyl)ethylidene-bis-1,3-isobenzofurandione; and diamines, such as 2,2-bis[4-(4-aminophenoxy)phenyl]propane, 2,2-bis[4-(4-aminophenoxy)phenyl]sulfone, 4,4′-diamino-2,2′-dimethylbiphenyl, and 4,4′-diamino-2,2′-hexafluorodimethylbiphenyl.

The polyimide resin having the functional group showing a characteristic infrared absorption wavelength contains the functional group showing the characteristic infrared absorption wavelength in an amount of 50 mole percent or more, preferably 70 mole percent or more, and more preferably 80 mole percent or more on the basis of the diamine or the acid dianhydride monomer from the standpoint that a satisfactory S/N ratio is secured and the thicknesses of respective layers can be measured with high accuracy.

The phrase “contains, as a principal component, a polyimide resin having a functional group showing a characteristic infrared absorption wavelength” means “contains a polyimide resin having a functional group showing a characteristic infrared absorption wavelength in an amount of 90 weight percent or more”.

### <Production of Polyimide Multilayer Adhesive Film>

An example of a method for producing a polyimide multilayer adhesive film of the present invention will now be described, but the present invention is not limited thereto.

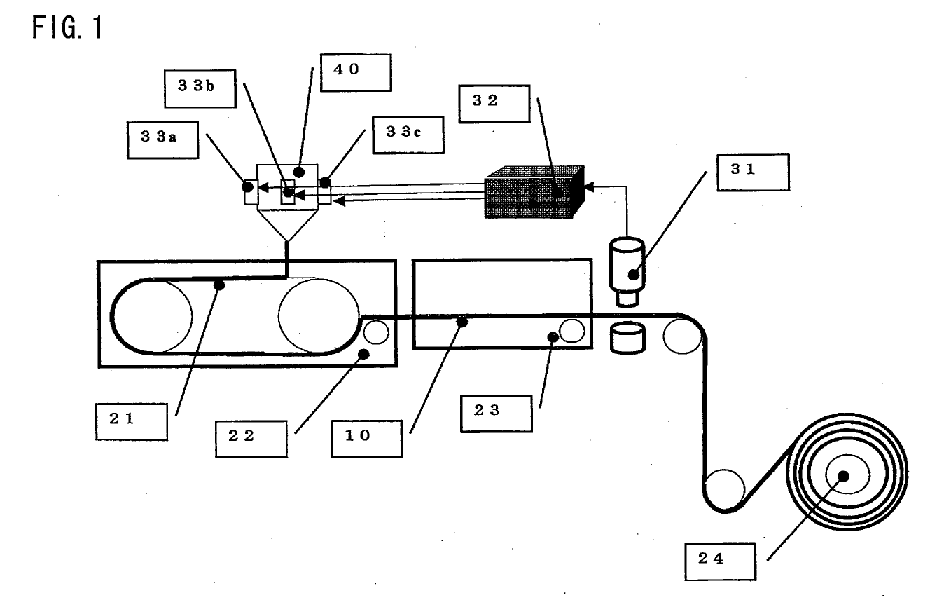

A method for producing an adhesive film of the present invention includes a step of forming a liquid film containing multiple layers on a support using two or more solutions each containing a polyimide resin or the precursor thereof, and a step of drying and promoting imidization. A known method such as a method using a multilayer die, a method using a slide die, a method in which a plurality of single-layer dies are arranged, and a method in which a single-layer die and spray coating or gravure coating are combined, can be employed as a method for forming the liquid film containing multiple layers on the support. However, in view of the productivity, the maintenance, and the like, the method using a multilayer die is particularly preferred. A method will now be described by way of an example using a multilayer die with reference to FIG. 1.

First, a solution containing the precursor of a highly heat-resistant polyimide and a solution containing a thermoplastic polyimide or a solution containing the precursor of the thermoplastic polyimide are supplied to a multilayer die 40 for extruding at least two layers. Both solutions are extruded from an orifice of the multilayer die 40 as a liquid film of multiple layers 10. Subsequently, the liquid film of the multiple layers 10 extruded from the multilayer die 40 is flow-cast on a smooth support 21 (an endless belt in FIG. 1) and the solvent in the liquid film of the multiple layers 10 on the support 21 is at least partially volatilized in a drying furnace 22. Thus, a self-supporting multilayer film 10 is prepared. Furthermore, the multilayer film 10 is peeled off from the support 21. Finally, the multilayer film 10 is satisfactorily heated in a tenter furnace 23 at a high temperature (250° C. to 600° C.) so that the solvent is substantially removed and imidization proceeds. Thus, the target polyimide multilayer film 10 is produced and is taken up by a take-up unit 24.

In order to improve the melt fluidity of the adhesive layer in the tenter furnace 23, this operation may be carried out intentionally with a low temperature of the tenter furnace 23 or a short time taken to pass through the tenter furnace, so that the imidization ratio may be decreased and/or the solvent may be allowed to remain.

In other words, a solution containing the precursor of a highly heat-resistant polyimide and a solution containing a thermoplastic polyimide or a solution containing the precursor of the thermoplastic polyimide are supplied to a multilayer die for extruding at least two layers. Both solutions are extruded from an orifice of the multilayer die as a liquid film of multiple layers. Subsequently, the liquid film of the multiple layers extruded from the multilayer die is flow-cast on a smooth support and the solvent in the liquid film of the multiple layers on the support is at least partially volatilized. Thus, a self-supporting multilayer film is prepared. Furthermore, the multilayer film is peeled off from the support. Finally, the multilayer film is satisfactorily heated at a high temperature (250° C. to 600° C.) so that the solvent is substantially removed and imidization proceeds. Thus, the target adhesive film is produced. In order to improve the melt fluidity of the adhesive layer, the imidization ratio may be decreased intentionally, and/or the solvent may be allowed to remain intentionally.

In general, polyimides are produced from precursors of polyimides, that is, polyamic acids, by dehydration conversion. As methods for performing the conversion, two methods, i.e., a thermal cure method in which the conversion is performed only by heating and a chemical cure method in which a chemical curing agent is used, are most widely known. In view of production efficiency, the chemical cure method is more preferred.

Any known multilayer die, such as a multi-manifold type, a feed-block type, or a mixture thereof, may be used.

Considering the applications of the resulting adhesive film, the support preferably has a surface as smooth as possible. Furthermore, considering the productivity, the support is preferably an endless belt or a drum.

The chemical curing agent includes a dehydrating agent and a catalyst. The term “dehydrating agent” means a cyclodehydrating agent for polyamic acids. Examples of the principal component of the cyclodehydrating agent that can be preferably used include aliphatic acid anhydrides, aromatic acid anhydrides, N,N′-dialkylcarbodiimides, lower aliphatic halides, halogenated lower aliphatic acid anhydrides, arylsulfonic acid dihalides, thionyl halides, and a mixture of two or more of these. Among these, in particular, the aliphatic acid anhydrides and the aromatic acid anhydrides satisfactorily act. The term “catalyst” means a component having an effect of accelerating the cyclodehydration by the curing agent on the polyamic acid. Examples of the catalyst that can be used include aliphatic tertiary amines, aromatic tertiary amines, and heterocyclic tertiary amines. Among these, nitrogen-containing heterocyclic compounds, such as imidazole, benzimidazole, isoquinoline, quinoline, and β-picoline, are preferred. Furthermore, the present invention may be arranged if appropriate such that a solution containing the dehydrating agent and the catalyst contains a polar organic solvent.

The method for volatilizing the solvent from the solution containing the precursor of the highly heat-resistant polyimide and the solution containing the thermoplastic polyimide or the solution containing the precursor of the thermoplastic polyimide is not particularly limited. The method including heating and/or air-blowing is the simplest method. If the heating temperature is excessively high, the solvent is rapidly volatilized and traces of the volatilization may cause micro-defects in the resulting adhesive film. Therefore, the heating temperature is preferably less than 50° C. higher than the boiling point of the solvent used.

Regarding the imidization time, a time sufficient to substantially complete imidization and drying may be selected. In general, the imidization time is appropriately set in the range of about 1 to 600 seconds, but is not exclusively limited.

The tension applied during imidization is preferably in the range of 1 kg/m to 15 kg/m and particularly preferably in the range of 5 kg/m to 10 kg/m. If the tension is lower than the above range, sagging and meandering may occur during the moving of the film, resulting in problems that wrinkles may be generated during taking-up of the film, the film may not be taking up uniformly, and the like. If the tension is higher than the above range, since the film is heated at a high temperature under high tension, the dimensional properties of the resulting flexible metal-clad laminate may be degraded.

Next, description will be made of the step of irradiating the resulting multilayer film with infrared rays in the thickness direction of the film to measure the distribution of the absorption wavelengths of the infrared rays, and calculating the thickness dimensions of the respective layers from the amounts of absorption of the infrared rays in the wavelength regions characteristic of the respective layers.

The film thickness measuring device that can be used in this step is an infrared absorption type film thickness measuring device based on the following principle: When a film to be measured is perpendicularly irradiated with infrared rays having wave lengths of 400 cm⁻¹ to 4,000 cm⁻¹ in the thickness direction of the film, in the transmitted infrared rays, a difference in the amount of absorption that depends on the thickness dimension is measured at a wavelength that is characteristic of the relevant substance. The film thickness is calculated from the difference in the amount of absorption.

Consequently, in the present invention, since at least one layer of the multilayer film contains, as a principal component, a polyimide resin having a functional group showing a characteristic infrared absorption wavelength, the total thickness of the multilayer film can be calculated from the amount of absorption of the infrared rays at a wavelength that is characteristic of polyimide resins and the thickness of the polyimide resin having a functional group showing a characteristic infrared absorption wavelength can be calculated from the amount of absorption of the infrared rays of this polyimide resin.

For example, a multilayer film includes a highly heat-resistant polyimide layer and adhesive layers containing a thermoplastic polyimide, the adhesive layers being provided on both surfaces of the highly heat-resistant polyimide layer. In the above three-layer polyimide film, one of the adhesive layers contains, as a principal component, a polyimide resin having a functional group showing a characteristic infrared absorption wavelength and the other adhesive layer contains, as a principal component, a polyimide resin having a functional group showing another characteristic infrared absorption wavelength. When the film thickness of the three-layer polyimide film is measured with the above-described infrared absorption type film thickness measuring device, the total thickness dimension of the three-layer polyimide film and the thickness dimensions of the respective adhesive layers can be measured. It is self-evident that the thickness dimension of the highly heat-resistant polyimide layer is calculated by subtracting the thickness dimensions of the respective adhesive layers from the total thickness dimension of the three-layer polyimide film. When the total of the thickness dimensions of the adhesive layers disposed on both sides or only the thickness dimension of the highly heat-resistant polyimide layer is required, it is sufficient that either the adhesive layer or the highly heat-resistant polyimide layer contains a functional group showing a characteristic infrared absorption wavelength.

An infrared absorption type thickness gauge 31 may be disposed at any position as long as the multilayer film can be measured. When the amount of heat shrinkage is known in advance, the thickness gauge 31 may be disposed near the orifice of the multilayer die 40 or near the outlet of the drying furnace 22. For high accuracy in measuring the final thickness dimension it is preferable to measure the multilayer film 10 that has been completely imidized in the tenter furnace 23 and then cooled to about room temperature. Therefore, the thickness gauge 31 is preferably disposed between the tenter furnace 23 and the take-up unit 24.

Next, description will be made of the step of feeding back the calculated data of the thickness dimensions to the multilayer film-forming step, and the step of controlling the thickness dimension of each layer in the film-forming step.

The data of the thickness dimensions of respective layers that has been measured with the thickness gauge 31 and calculated with a film-thickness control system 32 is fed back to film-thickness dimension control means 33 installed in the multilayer die 40. When the thickness is out of a desired thickness dimension, the film-thickness dimension control means 33 controls the thickness to the desired thickness dimension.

Various film-thickness dimension control means 33 that can feedback the data of the thickness dimensions of respective layers measured with the thickness gauge 31 and that can continuously control the film thickness can be used as the film-thickness dimension control means 33 in the present invention.

Specific film-thickness dimension control means of the present invention will be described, by way of example, with respect to a multilayer die.

With respect to the multilayer die used, the number of the layers and the type of the multilayer die used in the present invention are not particularly limited as long as a polyimide multilayer film can be produced from solutions containing at least two types of polyimide resins or the precursors thereof.

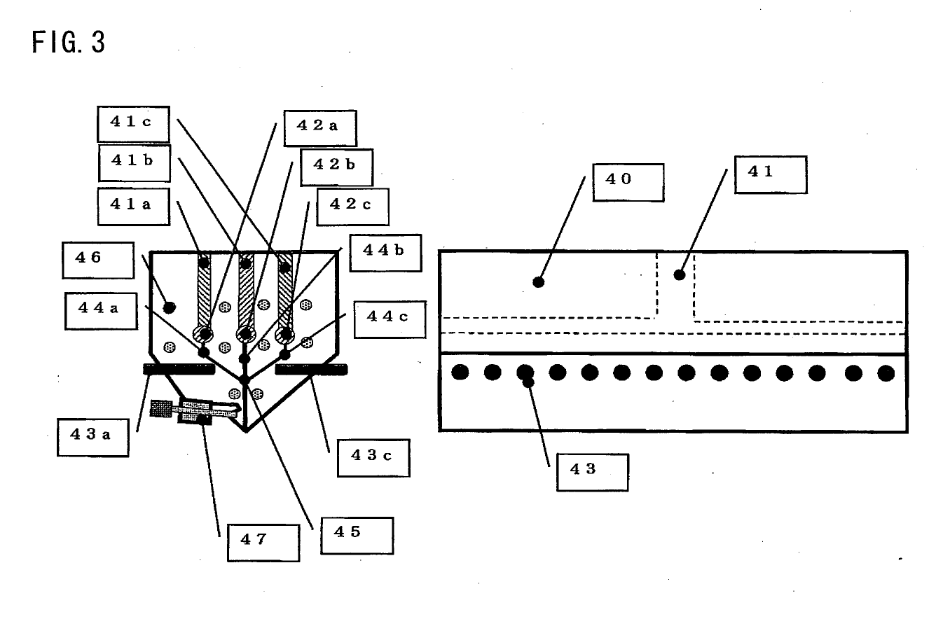

A specific example of a multi-manifold type multilayer die used in the present invention will now be described with reference to FIG. 3.

In the present invention, a heating element is used for adjusting the thicknesses of respective layers of a multilayer film. In the film formation by coextrusion, since at the downstream of a manifold, the die has a flow path that is a plate-shaped space having a very small thickness, high fluid resistance is generated in a fluid passing through the flow path. Therefore, when the viscosity of the fluid is changed, the fluid resistance is changed, resulting in a change in the discharge quantity of the fluid. Consequently, the thickness dimension is changed.

First, solutions A, B, and C each containing a polyimide resin or the precursor thereof (hereinafter also simply referred to as solutions A, B, and C) are injected in the die through injection paths 41a, 41b, and 41c, respectively. After the polyimide resin solutions are injected from the respective injection paths 41, the solutions are spread in the width direction at manifolds 42a, 42b, and 42c and then flow in flow paths 44 in this state. Since each of the flow paths 44 generally has a thickness of about several tens to several hundreds of micrometers, high fluid resistance is generated in each solution containing a polyimide resin or the precursor thereof. Therefore, when the viscosity of the solution is decreased, the flow rate of the solution is increased. For example, solution A flowing in the flow path 44a is heated by heating the vicinity of the flow path 44a with a heating element 43a, so that the viscosity of polyimide resin solution A is decreased. This results in an increase in the discharge quantity from the flow path 44a. When the discharge quantity is increased, the ratio of solution A to polyimide resin solutions B and C is increased in the downstream of a junction point 45, resulting in an increase in the thickness of polyimide resin solution A in the liquid film. Similarly, the thickness of solution C flowing in the flow path 44c can be controlled with a heating element 43c.

A lip-adjusting mechanism 47 adjusts the total thickness of the multilayer film. The thicknesses of polyimide resin solutions A and C are adjusted with the heating elements 43a and 43c, respectively, and the total film thickness is adjusted with the lip-adjusting mechanism 47. In this case, since the ratio of the film thickness of solution A to that of solution C is not changed, the film thickness of polyimide resin solution B can also be adjusted.

A mechanism that can be used for the lip-adjusting mechanism 47 is a mechanism that can physically increase or decrease the gap between die lips. Examples thereof include a heat bolt style in which an end of a heating element is fixed to a die and the heating element is expanded to move die lips, and a style in which die lips are moved with a motor or the like.

Any method that is industrially or generally used can be employed for the heating element in the present invention without limitation. In particular, a heating element in which a resistive element composed of, for example, a metal, carbon, or an inorganic compound is heated by supplying a current is preferred because it can be easily handled and has a satisfactory responsiveness. An electromagnetic induction type heating element is more preferred because of its higher responsiveness.

The heating elements in the present invention are used for respectively controlling the thicknesses of respective layers of a multilayer film. Therefore, regarding the position of the heating elements, it is obviously important that the heating elements are disposed at positions upstream of the junction point of the solutions each containing a polyimide resin or the precursor thereof. Furthermore, the thickness dimension at a specific position in the width direction of each film layer can also be controlled by continuously disposing the heating elements in the width direction of the flow path that is spread in the width direction.

In such a case, however, the measurement of a distribution of the film thickness dimensions in the width direction requires a mechanism having a plurality of thickness gauges disposed in the width direction or a single thickness gauge movable in the width direction so that the data can be obtained with a predetermined pitch by controlling a thickness gauge in the width direction. However, by uniformly stabilizing the distributions of the film thickness in the flow direction and in the width direction of the film, a multilayer film with high quality can be produced.

When the heating elements are continuously disposed, the intervals of the heating elements are not particularly limited and the intervals necessary and sufficient for the control are selected. In general, the heating elements are preferably disposed at intervals of 5 to 50 mm because excessively small intervals of the heating elements may cause mutual interference. Because of the best balance between the uniformity of the film thickness and mutual interference, the interval is more preferably 7 to 20 mm.

In the present invention, it is effective that the multilayer die is cooled by circulating a cooling medium in a hole made inside the multilayer die. The precursors of polyimide resins are generally subjected to intramolecular dehydration reaction and are cured at high temperatures. In the multilayer die having the film-thickness control mechanism with the heating elements of the present invention, the temperature of the die tends to be gradually increased. Consequently, the resin in the flow path in the die is solidified and adhered to the flow path, resulting in poor film-forming property and contamination of the film with the solidified.

Examples of a cooling unit include the above method in which a cooling medium is circulated in the multilayer die, and a method in which a pipe is wound on the outside of the multilayer die and a cooling medium is circulated therein. Alternatively, an air-flow may be blown to the outside of the multilayer die or fins may be provided to improve the cooling effect.

The temperature of the cooled multilayer die is preferably room temperature or lower, more preferably 10° C. or lower, and most preferably 0° C. or lower. However, an excessively low temperature excessively increases the viscosity of a polyimide compound varnish, resulting in a difficulty in handling. Therefore, the temperature of the multilayer die is preferably −15° C. or higher and more preferably −10° C. or higher.

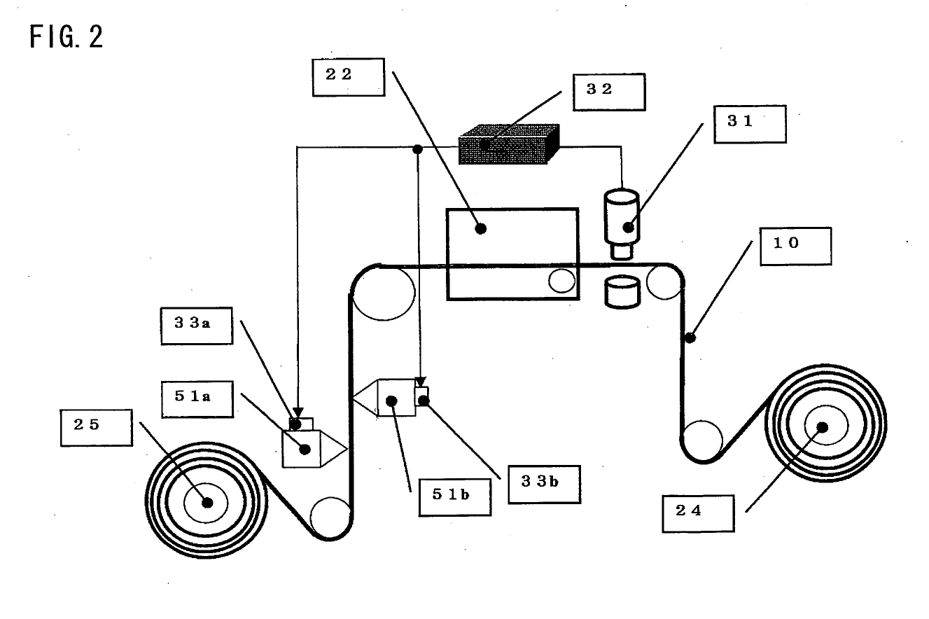

Next, a method for forming a film will be described, in which a solution containing a polyamic acid or a polyimide resin is coated on a surface of a film composed of at least one layer containing a polyimide resin and then heated and dried. A method for producing a polyimide multilayer film will now be described with reference to FIG. 2, in which a film including at least one layer containing a highly heat-resistant polyimide resin is used as a core layer, a solution containing a thermoplastic polyimide or a solution containing the precursor of a thermoplastic polyimide is coated as a clad layer on both sides of the core layer by a coating method.

First, a highly heat-resistant polyimide film including a single layer or a plurality of layers is fed as a core layer with a feeding unit 25 into a coating apparatus. A solution containing a thermoplastic polyimide or a solution containing the precursor of a thermoplastic polyimide is discharged from a coating die 51 that stably coats both sides of the core layer with the solution to form a clad layer. Subsequently, the solvent in the liquid film of the clad layer is volatilized in a drying furnace 22 and imidization proceeds at the same time. Thus, the target polyimide multilayer film 10 is produced and is taken up by a take-up unit 24.

In addition to the coating die, a roll coater method, a gravure roll method, and a spray method, and the like are known as the coating method, and any method may be employed. The installation position of an infrared absorption type thickness gauge 31 is the same as that in the above multilayer die method. The infrared absorption type thickness gauge 31 is preferably disposed between the drying furnace 22 and the take-up unit 24. Regarding a method for controlling the film thickness in the coating method, the discharge quantity from the coating die may be controlled with a pump for supplying the resin. In the coating method using a roll coater, a method for controlling the thickness dimension of the coating film by, for example, controlling the space between the base film and the roll coater can be employed.

### EXAMPLES

The present invention will now be described more specifically together with examples of a method of the present invention, but the examples do not limit the present invention.

### Synthesis Example 1

### Synthesis of Polyamic Acid Serving as Precursor of Highly Heat-Resistant Polyimide Compound

First, 76.2 kg of DMF cooled at 10° C. and 3.7 kg of p-phenylenediamine (PDA) were fed. Subsequently, 9.8 kg of 3,3′,4,4′-biphenyltetracarboxylic dianhydride (BPDA) was gradually added under stirring in a nitrogen atmosphere, and the mixture was stirred for 30 minutes. A solution is separately prepared by dissolving 300 g of BPDA in 2 kg of DMF, and this solution was gradually added to the above reaction solution under stirring while the viscosity was carefully monitored. The addition and the stirring were stopped when the viscosity reached 3,500 poise. Thus, a polyamic acid solution serving as the precursor of a highly heat-resistant polyimide compound was prepared.

In this synthesis example, when the thickness of each layer is measured with an infrared absorption method, there is no functional group showing a characteristic infrared absorption wavelength.

### Synthesis Example 2

### Synthesis of Polyamic Acid Serving as Precursor of Highly Heat-Resistant Polyimide Compound

Into 239 kg of N,N-dimethylformamide (hereinafter also referred to as “DMF”) cooled at 10° C., 6.9 kg of 4,4′-oxydianiline (hereinafter also referred to as “ODA”), 6.2 kg of p-phenylenediamine (hereinafter also referred to as “p-PDA”)), and 9.4 kg of 2,2-bis[4-(4-aminophenoxy)phenyl]propane (hereinafter also referred to as “BAPP”) were dissolved. Subsequently, 10.4 kg of pyromellitic dianhydride (hereinafter also referred to as “PMDA”) was added to the solution and the solution was stirred for one hour to dissolve the PMDA. Furthermore, 20.3 kg of benzophenonetetracarboxylic dianhydride (hereinafter also referred to as “BTDA”) was added to the resultant solution, and the solution was stirred for one hour to dissolve the BTDA.

A DMF solution of PMDA (PDMA:DMF=0.9 kg:7.0 kg) that was separately prepared was gradually added to the reaction solution, and the addition was stopped when the viscosity reached about 3,000 poise. Stirring was performed for one hour to produce a polyamic acid solution serving as the precursor of a highly heat-resistant polyimide compound, the solution having a solid content of 18 weight percent and a rotational viscosity of 3,500 poise at 23° C.

In this synthesis example, when the thickness of each layer is measured with an infrared absorption method, the functional group showing a characteristic infrared absorption wavelength is methyl group derived from BAPP.

### Synthesis Example 3

### Synthesis of Polyamic Acid Serving as Precursor of Thermoplastic Polyimide Compound

First, 78 kg of DMF cooled at 10° C. and 11.56 kg of 2,2-bis[4-(4-aminophenoxy)phenyl]propane (BAPP) were fed, and 7.87 kg of 3,3′,4,4′-biphenyltetracarboxylic dianhydride (BPDA) was gradually added under stirring in a nitrogen atmosphere. Subsequently, 380 g of ethylenebis(trimellitic acid monoester anhydride) (TMEG) was added, and the solution was stirred for 30 minutes. A solution in which 300 g of TMEG was dissolved in 3 kg of DMF was separately prepared. This solution was gradually added to the above reaction solution under stirring while the viscosity was carefully monitored. The addition and the stirring were stopped when the viscosity reached 3,000 poise. Thus, a polyamic acid solution serving as the precursor of a thermoplastic polyimide compound was prepared.

In this synthesis example, when the thickness of each layer is measured with an infrared absorption method, the functional group showing a characteristic infrared absorption wavelength is methyl group derived from BAPP.

### Synthesis Example 4

### Synthesis of Polyamic Acid Serving as Precursor of Thermoplastic Polyimide Compound

First, 82.1 kg of DMF cooled at 10° C. and 12.18 kg of 2,2-bis[4-(4-aminophenoxy)phenyl]sulfone (BAPS) were fed, and 7.87 kg of 3,3′,4,4′-biphenyltetracarboxylic dianhydride (BPDA) was gradually added under stirring in a nitrogen atmosphere. Subsequently, 380 g of ethylenebis(trimellitic acid monoester anhydride) (TMEG) was added, and the solution was stirred for 30 minutes. A solution in which 300 g of TMEG was dissolved in 3 kg of DMF was separately prepared. This solution was gradually added to the above reaction solution under stirring while the viscosity was carefully monitored. The addition and the stirring were stopped when the viscosity reached 3,000 poise. Thus, a polyamic acid solution serving as the precursor of a thermoplastic polyimide compound was prepared.

In this synthesis example, when the thickness of each layer is measured with an infrared absorption method, the functional group showing a characteristic infrared absorption wavelength is a sulfone group derived from BAPS.

### Synthesis Example 5

### Synthesis of Polyamic Acid Serving as Precursor of Thermoplastic Polyimide Compound

First, 86.2 kg of DMF cooled at 10° C. and 6.6 kg of 1,3-bis(4-aminophenoxy)benzene (TPE-R) were fed, and 6.9 kg of 2,3′,3,4′-biphenyltetracarboxylic dianhydride (a-BPDA) was gradually added under stirring in a nitrogen atmosphere. A solution in which 300 g of TPE-R was dissolved in 3 kg of DMF was separately prepared. This solution was gradually added to the above reaction solution under stirring while the viscosity was carefully monitored. The addition and the stirring were stopped when the viscosity reached 3,000 poise. Thus, a polyamic acid solution serving as the precursor of a thermoplastic polyimide compound was prepared.

In this synthesis example, when the thickness of each layer is measured with an infrared absorption method, there is no functional group showing a characteristic infrared absorption wavelength.

Table 2 shows the resins and the characteristic infrared absorption functional groups in Synthesis Examples (1) to (5). (Measurement of thicknesses of respective layers of adhesive film)

The thicknesses of respective layers of a film were measured with a multilayer film thickness measuring device KE-500ML manufactured by Kurabo Industries Ltd. When the measuring device recognized the film as a multilayer film and could measure the thicknesses of respective layers, the result was represented by “Good”. When the measuring device could not recognize the film as a multilayer film and could not measure the thicknesses of respective layers, the result was represented by “Not good”.

### Example 1

The following chemical dehydrating agent and catalyst were added to the polyamic acid solution serving as the precursor of the highly heat-resistant polyimide prepared in Synthesis Example 1.

1. Chemical dehydrating agent: 2.0 moles of acetic anhydride per mole of the amic acid unit of the polyamic acid serving as the precursor of the highly heat-resistant polyimide.
2. Catalyst: 0.3 moles of isoquinoline per mole of the amic acid unit of the polyamic acid serving as the precursor of the highly heat-resistant polyimide.

Subsequently, a multilayer film that was formed in the order that an outer layer was formed from the polyamic acid solution serving as the precursor of the thermoplastic polyimide prepared in Synthesis Example 3 and an inner layer was formed from the polyamic acid solution serving as the precursor of the highly heat-resistant polyimide solution was continuously extruded from a multi-manifold type three-layer coextrusion multilayer die having a lip width of 650 mm to be flow-cast onto a stainless steel endless belt traveling 20 mm below the T-die. The multilayer film was then heated at 130° C. for 100 seconds, and thus the film was transformed into a self-supporting gel film. Delamination was not observed in the gel film, and the gel film had a satisfactory appearance. Furthermore, the self-supporting gel film was separated from the endless belt. The gel film was fixed to tenter clips and was dried and imidized at 300° C. for 30 seconds, at 400° C. for 50 seconds, and at 450° C. for 10 seconds to prepare an adhesive film.

The thicknesses of the respective layers of the polyimide adhesive film were measured with a multilayer film thickness measuring device KE-500ML manufactured by Kurabo Industries Ltd. As a result, the total thickness dimension of the three-layer film was measured from the amount of infrared absorption at a wave number of around 1,700 cm⁻¹, which is characteristic of the polyimide resin. The thickness of clad layer 1 could be measured from the amount of infrared absorption at a wave number of around 2,900 cm⁻¹, which is characteristic of methyl group, and the thickness of clad layer 2 could be measured from the amount of infrared absorption at a wave number of around 1,300 cm⁻¹, which is characteristic of a sulfone group. Accordingly, the thickness gauge was disposed at a step that followed the discharge of the film from a tenter. The thickness gauge had a mechanism in which the thickness was measured while the thickness gauge was moved in the width direction of the multilayer film at a rate of 120 mm/sec. The thickness dimensions of the respective layers of the multilayer film measured with the thickness gauge and the positions in the width direction of the film were sequentially transmitted to a control system. The control system transmitted a conduction signal including at least one of a conduction current and a conduction time to a heating element, and transmitted a rotational signal, which is an angle of motor rotation, to a lip-moving motor, these signals being transmitted at 5 second intervals, so as to obtain a desired thickness dimension. Thus, the film thickness dimension was controlled.

The variations in the film thicknesses of the resulting film were measured in the mechanical feed direction and in the width direction with the multilayer film thickness measuring device KE-500ML manufactured by Kurabo Industries Ltd. with a pitch of 10 mm. Each of the variations in the thicknesses of the respective layers was 8% or less.

### Example 2

An adhesive film was prepared as in Example 1 except that the polyamic acid solution serving as the precursor of the thermoplastic polyimide prepared in Synthesis Example 4 was used instead of the polyamic acid solution serving as the precursor of the thermoplastic polyimide prepared in Synthesis Example 3. Each of the variations in the thicknesses of the respective layers was 7% or less.

### Example 3

An adhesive film was prepared as in Example 1 except that the polyamic acid solution serving as the precursor of the highly heat-resistant polyimide prepared in Synthesis Example 2 was used instead of the polyamic acid solution serving as the precursor of the highly heat-resistant polyimide prepared in Synthesis Example 1, and the polyamic acid solution serving as the precursor of the thermoplastic polyimide prepared in Synthesis Example 5 was used instead of the polyamic acid solution serving as the precursor of the thermoplastic polyimide prepared in Synthesis Example 3. Each of the variations in the thicknesses of respective layers was 7% or less.

### Comparative Example 1

An adhesive film was prepared as in Example 1 except that the polyamic acid solution serving as the precursor of the thermoplastic polyimide prepared in Synthesis Example 5 was used instead of the polyamic acid solution serving as the precursor of the thermoplastic polyimide prepared in Synthesis Example 3.

### Comparative Example 2

An adhesive film was prepared as in Example 1 except that the polyamic acid solution serving as the precursor of the highly heat-resistant polyimide prepared in Synthesis Example 2 was used instead of the polyamic acid solution serving as the precursor of the highly heat-resistant polyimide prepared in Synthesis Example 1.

Table 1 shows the resin structures and the measurement results of the layer thickness of the respective layers in Examples 1 to 3 and Comparative Examples 1 and 2.

TABLE 1

| | Highly heat-resistant | | | | |
|---|---|---|---|---|---|
| | polyimide layer | | Adhesive layer | | |
| | Acid dianhydride/ | Diamine/ | Acid dianhydride/ | Diamine/ | Measurement |
| | mole % | mole % | mole % | mole % | result |
| Example 1 | BPDA/100 | PDA/100 | BPDA/95 TMEG/5 | BAPP/100 | Good |
| Example 2 | BPDA/100 | PDA/100 | BPDA/95 TMEG/5 | BAPS/100 | Good |
| Example 3 | PMDA/45 BTDA/55 | PDA/50 | a-BPDA/100 | TPE-R/100 | Good |
| | | BAPP/20 | | | |
| | | ODA/30 | | | |
| Comparative | BPDA/100 | PDA/100 | a-BPDA/100 | TPE-R/100 | Not good |
| Example 1 | | | | | |
| Comparative | PMDA/45 BTDA/55 | PDA/50 | BPDA/95 TMEG/5 | BAPP/100 | Not good |
| Example 2 | | BAPP/20 | | | |
| | | ODA/30 | | | |

TABLE 2

| | | Characteristic |
|---|---|---|
| | | infrared absorption |
| Synthesis Example | Resin | functional group |
| Synthesis 1 | Highly heat-resistant | None |
| | polyimide compound | |
| Synthesis 2 | The same as the above | Methyl group |
| Synthesis 3 | Thermoplastic | Methyl group |
| | polyimide compound | |
| Synthesis 4 | The same as the above | Sulfone group |
| Synthesis 5 | The same as the above | None |

TABLE 3

| Example | Clad 1 | Core | Clad 2 |
|---|---|---|---|
| Example 4 | Synthesis 3 | Synthesis 1 | Synthesis 4 |
| Example 5 | Synthesis 5 | Synthesis 2 | Synthesis 4 |
| Example 6 | Synthesis 3 | Synthesis 1 | Synthesis 3 |
| Comparative | Synthesis 5 | Synthesis 1 | Synthesis 5 |
| Example 3 | | | |
| Comparative | Synthesis 3 | Synthesis 2 | Synthesis 3 |
| Example 4 | | | |

As shown in Examples, when either of the highly heat-resistant polyimide layer or the adhesive layer contained, as a principal component, a polyimide resin having a functional group showing a characteristic infrared absorption wavelength, the thicknesses of respective layers could be precisely detected with an infrared absorption type thickness measuring device.

### Example 4

A three-layer polyimide film was formed by coextrusion using a three-layer coextrusion die shown in FIG. 3, in which a heating element 43 was attached to a multi-manifold type multilayer die 40. Table 3 shows the polyimide resin compositions of the core layer and the clad layers.

In the three-layer coextrusion die, a part of flow paths 44 disposed at both sides of the outer layers (referred to as clad layers 1 and 2) was heatable with a heating element 43 (6.5 mm in diameter, an electric sheath heater). The space between die lips was 0.8 mm and a lip-width-adjusting mechanism 47 has a mechanism for adjusting the space between the lips by moving a lip with a motor with an accuracy of 10 μm. These film-thickness dimension control mechanisms are disposed in the width direction of the multilayer die at 12.5 mm intervals. The multilayer die has a width of 600 mm. A cooling medium is circulated through a circulation hole 46 for the cooling medium that is provided in the multilayer die to cool the multilayer die at 0° C.

The following chemical dehydrating agent and catalyst were added to the polyamic acid solution serving as the precursor of the highly heat-resistant polyimide prepared in Synthesis Example 1

1. Chemical dehydrating agent: 2.0 moles of acetic anhydride per mole of the amic acid unit of the polyamic acid serving as the precursor of the highly heat-resistant polyimide.
2. Catalyst: 0.3 moles of isoquinoline per mole of the amic acid unit of the polyamic acid serving as the precursor of the highly heat-resistant polyimide.
Subsequently, a multilayer film was continuously extruded from the three-layer coextrusion die using the above polyamic acid solution serving as the precursor of the highly heat-resistant polyimide resin solution as the core layer, the polyamic acid solution serving as the precursor of the thermoplastic polyimide prepared in Synthesis Example 3 as the clad layer 1, and the polyamic acid solution serving as the precursor of the thermoplastic polyimide prepared in Synthesis Example 4 as the clad layer 2, and was flow-cast onto an stainless steel endless belt traveling at a rate of 15 m/min. The multilayer film was then heated at 130° C. for 100 seconds, and thus the film was transformed into a self-supporting gel film. Delamination was not observed in the gel film, and the gel film had a satisfactory appearance. Furthermore, the self-supporting gel film was separated from the endless belt. The gel film was fixed to tenter clips and was dried and imidized in a tenter furnace at 300° C. for 30 seconds, at 400° C. for 50 seconds, and at 450° C. for 10 seconds. Thus, a three-layer polyimide film including outer layers serving as the clad layers composed of the thermoplastic polyimide compounds and the central core layer composed of the highly heat-resistant polyimide compound was prepared.

The thicknesses of the respective layers of the resulting three-layer polyimide film were measured with a multilayer film thickness measuring device KE-500ML manufactured by Kurabo Industries Ltd. As a result, the total thickness dimension of the three-layer film was measured from the amount of infrared absorption at an absorption wavelength of around 1,700 cm⁻¹, which is characteristic of the polyimide resin. The thickness of clad layer 1 could be measured from the amount of infrared absorption at an absorption wavelength of around 2,900 cm⁻¹, which is characteristic of methyl group, and the thickness of clad layer 2 could be measured from the amount of infrared absorption at an absorption wavelength of around 1,300 cm⁻¹, which is characteristic of a sulfone group. Accordingly, the thickness gauge was disposed at a step after the film come out from the tenter furnace. The thickness gauge had a mechanism in which the thickness was measured while the thickness gauge was moved in the width direction of the multilayer film at a rate of 120 mm/sec. The thickness dimensions of the respective layers of the multilayer film measured with the thickness gauge and the positions in the width direction of the film were sequentially transmitted to a control system. The control system transmitted a conduction signal including at least one of a conduction current and a conduction time to the heating element, and transmitted a rotational signal, which is an angle of motor rotation, to the lip-moving motor, these signals being transmitted at 5 second intervals, so as to obtain a desired thickness dimension. Thus, the film thickness dimension was controlled.

As a result, each of the variations in the thickness dimensions of the respective layers when the film thickness dimensions were not controlled with the control system was 20%, whereas each of the variations in the thickness dimensions of the respective layers when the film thickness dimensions were controlled was within 1%. The variations in the thickness dimensions were calculated by measuring the thicknesses in the mechanical feed direction and in the width direction of the resulting film with the multilayer film thickness measuring device KE-500ML manufactured by Kurabo Industries Ltd with a pitch of 10 mm.

### Example 5

A three-layer polyimide film was prepared with the same apparatus as that in Example 1 except that the polyamic acid solution serving as the precursor of the thermoplastic polyimide prepared in Synthesis Example 5 was used as clad layer 1 instead of using the polyamic acid solution serving as the precursor of the thermoplastic polyimide prepared in Synthesis Example 3 as clad layer 1, and the polyamic acid solution serving as the precursor of the highly heat-resistant polyimide prepared in Synthesis Example 2 was used as the core layer instead of using the polyamic acid solution serving as the precursor of the highly heat-resistant polyimide prepared in Synthesis Example 1. Table 3 shows the polyimide resin compositions of the core layer and the clad layers.

As a result, each of the variations in the thickness dimensions of the respective layers when the film thickness dimensions were not controlled with the control system was 20%, whereas each of the variations in the thickness dimensions of the respective layers when the film thickness dimensions were controlled was within 1%.

### Example 6

A three-layer polyimide film was prepared with the same apparatus as that in Example 1 except that the polyamic acid solution serving as the precursor of the thermoplastic polyimide prepared in Synthesis Example 3 was used as clad layer 1 and clad layer 2 instead of using the polyamic acid solution serving as the precursor of the thermoplastic polyimide prepared in Synthesis Example 4 as clad layer 2. Table 3 shows the polyimide resin compositions of the core layer and the clad layers.

As a result, each of the variations in the thickness dimensions of the respective layers when the film thickness dimensions were not controlled with the control system was 20%, whereas the variation in the thickness dimension of the core layer when the film thickness dimension was controlled was within 1% and each of the variations in the thickness dimensions of the respective clad layers when the film thickness dimensions were controlled was within 2%.

### Comparative Example 3

A three-layer polyimide film was prepared as in Example 1 except that the polyamic acid solution serving as the precursor of the thermoplastic polyimide prepared in Synthesis Example 5 was used as clad layers 1 and 2 instead of using the polyamic acid solution serving as the precursor of the thermoplastic polyimide prepared in Synthesis Example 2. Table 3 shows the polyimide resin compositions of the core layer and the clad layers.

The thicknesses of the respective layers of the resulting three-layer polyimide film were measured with a multilayer film thickness measuring device KE-500ML manufactured by Kurabo Industries Ltd. As a result, the total thickness dimension of the three-layer film could be measured from the amount of infrared absorption at an absorption wavelength that is characteristic of the polyimide resin, but the thickness dimensions of respective layers could not measured. The thicknesses of the respective layers could not be controlled.

### Comparative Example 4

A three-layer polyimide film was prepared with the same apparatus as that in Example 1 except that the polyamic acid solution serving as the precursor of the highly heat-resistant polyimide prepared in Synthesis Example 2 was used as the core layer instead of using the polyamic acid solution serving as the precursor of the highly heat-resistant polyimide prepared in Synthesis Example 1, and the polyamic acid solution serving as the precursor of the thermoplastic polyimide prepared in Synthesis Example 3 was used as clad layer 2 instead of using the polyamic acid solution serving as the precursor of the thermoplastic polyimide prepared in Synthesis Example 4. Table 3 shows the polyimide resin compositions of the core layer and the clad layers.

The thicknesses of the respective layers of the resulting three-layer polyimide film were measured with a multilayer film thickness measuring device KE-500ML manufactured by Kurabo Industries Ltd. As a result, the total thickness dimension of the three-layer film could be measured from the amount of infrared absorption at an absorption wavelength that is characteristic of the polyimide resin, but the thickness dimensions of respective layers could not measured. The thicknesses of the respective layers could not be controlled.

1. A polyimide multilayer adhesive film comprising a highly heat-resistant polyimide layer and an adhesive layer that contains a thermoplastic polyimide and that is disposed on at least one surface of the highly heat-resistant polyimide layer, wherein the highly heat-resistant polyimide layer or the adhesive layer contains, as a principal component, a polyimide resin having a functional group showing a characteristic infrared absorption wavelength and each of variations in thicknesses of the respective layers is ±10% or less of an average thickness of the respective layers.

2. A polyimide multilayer adhesive film comprising a highly heat-resistant polyimide layer and an adhesive layer that contains a thermoplastic polyimide and that is disposed on at least one surface of the highly heat-resistant polyimide layer, wherein the adhesive film is produced by a coextrusion-flow casting method and the highly heat-resistant polyimide layer or the adhesive layer contains, as a principal component, a polyimide resin having a functional group showing a characteristic infrared absorption wavelength.

3. The polyimide multilayer adhesive film according to claim 1, wherein the adhesive film has a three-layer structure comprising a highly heat-resistant polyimide layer and adhesive layers that contain a thermoplastic polyimide and that are disposed on both surfaces of the highly heat-resistant polyimide layer, and at least two of the three layers are layers each containing, as a principal component, a polyimide resin having a functional group showing a different characteristic infrared absorption wavelength.

4. The polyimide multilayer adhesive film according to claim 1, wherein the functional group showing a characteristic infrared absorption wavelength is methyl group, sulfone group, or fluoromethyl group.

5. A method for producing a polyimide multilayer adhesive film, the polyimide resin-containing multilayer film having at least two layers, comprising forming a polyimide multilayer adhesive film including at least one layer containing, as a principal component, a polyimide resin having a functional group showing a characteristic infrared absorption wavelength; irradiating the adhesive film with infrared rays in a thickness direction of the film to measure a distribution of absorption wavelengths of the infrared rays, and calculating thickness dimensions of the respective layers from the amounts of absorption of the infrared rays in the wavelength regions characteristic of the respective layers; and feeding back the calculated data of the thickness dimensions to the step of forming, and controlling the thickness dimension of each layer in the step of forming.

6. The method for producing a polyimide multilayer adhesive film according to claim 5, wherein the polyimide multilayer film comprises a layer containing a highly heat-resistant polyimide resin and a layer containing a thermoplastic polyimide resin.

7. The method for producing a polyimide multilayer adhesive film according to claim 6, wherein the polyimide multilayer film has a structure in which the layers containing a thermoplastic polyimide resin are provided on both surfaces of the layer containing a highly heat-resistant polyimide resin.

8. The method for producing a polyimide multilayer adhesive film according to claim 5, wherein, in the step of forming, the film is coating, with a solution containing a polyamic acid or a polyimide resin, the surface of a film having at least one layer containing a polyimide resin, and thermally drying the film.

9. The polyimide multilayer adhesive film according to claim 2, wherein the film is an adhesive film having a three-layer structure comprising the highly heat-resistant polyimide layer, and the adhesive layers on both the sides of the highly heat-resistant polyimide layer, and at least two of the three layers contain as a principal component, the polyimide resin having the functional group showing the characteristic infrared absorption wavelength.

10. The polyimide multilayer adhesive film according to claim 2, wherein the functional group showing a characteristic infrared absorption wavelength is methyl group, sulfone group, or fluoromethyl group.
